(19) United States
(12) Patent Application Publication
(10) Pub. No.: US 2006/0089902 A1
(43) Pub. Date: Apr. 27, 2006

(54) Method and system for the financial feasibility of time-sharing of retirement community units using reverse mortgages

(76) Inventors: Yong On Kim, Palisades, NY (US); Ashish Kumar Dev, Shaker Heights, OH (US)

Correspondence Address: Mr. Yong O. Kim, 418 White Oak Road, Palisades, NY, 10964, US

(21) Appl. No.: 10/970,942

(22) Filed: Oct. 22, 2004

(51) Int. Cl. G06Q 40/00

(52) U.S. Cl. 705/38

(57) ABSTRACT

This invention relates to retirement communities. Specifically, a computer-implemented method and system enhances retired homeowners' accessibility to the retirement community on time-sharing basis and broadens the client base for the management and/or developers of such communities. The method particularly addresses the needs of those retired homeowners who will consider joining a retired community only a portion of the year while keeping their current homes. It determines the affordability of retirement community living on a time-sharing basis for retired homeowners, using reverse mortgages. The method also addresses the needs of developers of retirement community projects. It does a break-even analysis of the project under different scenarios, enabling a developer to assess the project's feasibility.

### REFERENCES

### U.S. Patent Documents

| | | |
|---|---|---|
| 20040015389 | January, 2004 | Dubner, Peter H. |
| 20040006507 | January, 2004 | Laufer, Aharon |
| 20040138990 | July, 2004 | Hardin, Loraine; et al. |
| 20030023544 | January, 2003 | Chodes, Gary |
| 20020138312 | September, 2002 | Blau, Joseph D. |
| 20020055905 | May, 2002 | Jannah, Shekar; et al. |

### Other References

Reverse mortgages from FannieMae web cite, eFannieMae.com National Reverse Mortgage Lenders Association web cite, www.reversemortgage.org Federal Reserve Board's Flow of Funds Accounts of the United States, 2003

### BACKGROUND OF THE INVENTION

1. Field of Invention

The present invention generally relates to a method and system that permits enhanced access to time-sharing of retirement community for retired homeowners. It also relates to a method and system that enables the management/developers of retirement communities to approach a broader segment of retired homeowners who may be reluctant to move permanently to a retirement community but consider joining retirement communities on time-sharing basis. More specifically, the present invention is directed to a method that produces the number of months of stay in the retirement community per year (e.g., six months) by a retiree who finances this arrangement primarily by reverse mortgage.

2. Description of the Related Art

As the population is growing older and the older generation lives longer, the demand for retirement communities will grow. However, a large segment of retired homeowners may be reluctant to move permanently to a retirement community due to their network of friends and family members (children and relatives) in their current residential areas. Time-sharing arrangement of retirement community may be an alternative arrangement for this group of retirees. As for the management or developers of retirement communities, this time-sharing arrangement provides them an opportunity to fill vacancies at cost-efficient way. Reverse mortgages are particularly well suited for financing this type of arrangement.

A reverse mortgage is a special type of loan used by elderly seniors to convert the equity in their homes into cash. Without reverse mortgage, many seniors who do not have adequate retirement funds except equity built-up in their homes must sell their homes and move to new places in order to get the cash out of the home. No payments are due on a reverse mortgage while it is outstanding. The loan becomes due and payable when the borrower ceases to occupy his/her home as a principal residence. This can occur if the borrower (the last remaining spouse, in cases of couples) passes away, sells the home, or permanently moves out.

The money from a reverse mortgage can be used for anything: daily living expenses; home repairs and home modifications; medical bills and prescription drugs; pay-off of existing debts; continuing education; travel; long-term health care; prevention of foreclosure; and other needs. The borrower can choose how to receive the money from a reverse mortgage. The options are: all at once (lump sum); fixed monthly payments (for up to life); a line of credit; or a combination of these. The most popular option is the line of credit, which allows the borrower to draw on the loan proceeds at any time. The size of a reverse mortgage varies with: (1) the borrower's age; (2) the value of the home; and (3) current interest rates. The location of the home also affects the loan size. The maximum size of a reverse mortgage depends on the FHA loan limit, which varies from area to area and is usually adjusted annually. For example, as of 2004, the FHA loan limit varies from a low of $160,176 for rural areas to a high of $290,319 for high-cost metropolitan areas.

Senior homeowners can use reverse mortgages to purchase a second home whose price is lower than the FHA loan limit. In this way, they can maintain their current primary residencies while enjoying the luxury of owning a second home. One can advance this idea one step further: Living in retirement communities on time-sharing basis (say, one to six months per year) can be financed with reverse mortgages. The time-sharing arrangement provides those senior homeowners a more efficient utilization of second home.

Computer systems can assist in determining if retirees can afford this retirement community time-sharing arrangement and if a developer can offer a cost-effective retirement community for both groups of seniors, those who wish to buy units and those who wish to rent units on time-sharing basis. For example, a software used by a retirement community sales person allows the users (both sales person and applicant) to enter the appropriate information (e.g., applicant's age, the location of his/her house, the house value, values of other assets, etc.) and the software will generate the maximum number of months per year (e.g., six months) that the applicant can stay in the retirement community by financing this arrangement primarily by reverse mortgage. The same software used by a retirement community developer generates the break-even monthly revenue per unit for the retirement community. Hence, it assists developers to determine whether the development of the retirement community is feasible based on the comparison between the break-even monthly revenue plus maintenance fee per unit and monthly cash flows of reverse mortgages for average retirees.

### SUMMARY AND OBJECTIVES OF THE PRESENT INVENTION

A computer-implemented method used in determining the affordability of a retirement community on time-sharing basis for retirees who would finance this arrangement primarily by reverse mortgages, and the feasibility of developing retirement communities for developers.

Given the current mortgage rate and the unit rent and maintenance fee per month of the retirement community, the method first calculates the maximum number of months per year (e.g., six months) that an applicant can afford to stay in the retirement community by inputting the appropriate information on the applicant such as the applicant's age, the location of the applicant's house, the house value, values of other assets, etc. Base monthly rent for units is determined by converting sales price of units to equivalent monthly cash flow over a specified period. However, actual monthly rents for peak period and off-peak period will be adjusted based on operating and advertising cost for time-sharing units, and peak and off-peak period vacancy rates.

Monthly maintenance fee for owners is based on the monthly maintenance cost per unit. However, the monthly maintenance fee for renters on time-sharing basis will be higher after adjusting for vacancy rates for rental units.

Break-even monthly rent per unit is determined by converting the break-even unit price to equivalent monthly cash flow over a specified period. Then the feasibility of developing a retirement community is determined by comparing the estimated monthly cash flows from reverse mortgages for average homeowner retirees and the break-even rent plus maintenance fee per month.

Benefit of this invention is for a large segment of retired homeowners who may be reluctant to move permanently to a retirement community but would like to have an access to retirement community on time-sharing basis, and for the management or developers of retirement communities to reach a much broader segment of clients. Financing this type of time-sharing arrangement by reverse mortgages is particularly well suited.

### BRIEF DESCRIPTION OF THE DRAWINGS

FIG. 1 depicts an information flow chart relevant to determining the applicant's affordability of retirement community living on time-sharing basis. It depicts in block diagram format, the estimation of number of months that the applicant can rent a unit during peak and/or off-peak periods given monthly rents and maintenance fees for peak and off-peak periods.

FIG. 2 depicts in block diagram format, the estimation of break-even rents and maintenance fees per month for peak and off-peak periods.

### DETAILED DESCRIPTION OF THE INVENTION

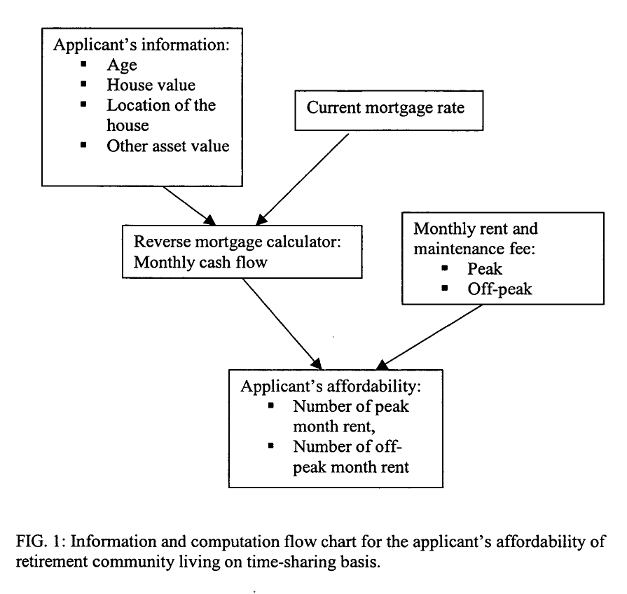

In FIG. 1, applicant's information and mortgage rate will yield either monthly cash flow or lump sum amount of reverse mortgage depending on what the applicant wants. Although these numbers are obtained based on the bank-assessed house value, the FHA limit and the current mortgage rates, these numbers do not correspond to the usual calculation of mortgage payment of conventional loans. This is because the maturity of the reverse mortgage is uncertain and based on the life expectancy. Since HUD posts periodically new FHA limits on the lump sum amount and/or monthly cash flows of the reverse mortgage, the system needs to be updated accordingly.

We will provide, however, a calculator for reverse mortgage with assumption on some parameter as follows. Let
CF: monthly cash flows from reverse mortgage
R: monthly mortgage rate
L: life expectancy of a borrower
V: upfront lump sum amount of reverse mortgage

Assume that reverse mortgage's maturity is set at L+a for a>0 where a is an extra number of years in order to protect reverse mortgage lenders in the case that the borrower lives longer than the life expectancy. Then, future value of this loan at the year L+a from today is
FV=V·(1+r)^{12(L+a)}

Note that FV and V must be lower than the assessed house value and FHA limit respectively. Hence, monthly cash flows from the reverse mortgage is
CF=r·FV/(1+r)^{12(L+a)-1}

Let
X: number of years of time-sharing contract
n: the number of months during the peak period
m: the number of months during the off-peak period

Typically, n+m≦0.5 since the retired homeowner would maintain the current home as a primary residence. Further, let
R_peak: monthly rent during peak period
R_off-peak: monthly rent during off-peak period
C_peak: monthly maintenance fee during peak period
C_off-peak: monthly maintenance fee during off-peak period

Suppose that the applicant is about to sign a contract that becomes effective immediately. Further, time now is in peak period, and off-peak begins n month after. Then, the present value of monthly rent and maintenance payments over one year can be expressed as

$$PV ( 1 \text{-} yr rent \& maintenance ) = ( R\_peak + C\_peak ) \{ 1 + [ 1 - 1 / {( 1 + r )}^{n - 1} ] / r \} + ( R\_off \text{-} peak + C\_off \text{-} peak ) \{ 1 + [ 1 - 1 / {( 1 + r )}^{n + m - 1} ] / r \}$$

Suppose the applicant chooses to receive monthly payments from the reverse mortgage. The present value of monthly cash flows from reverse mortgage over one year period is
PV(1-yr CF from reverse mortgage)=CF[1−1/(1+r)¹²]/r

In this case, the applicant can afford to sign the contract for this time-sharing arrangement, if
PV(1-yr CF from reverse mortgage)>PV(1-yr rent & maintenance)

On the other hand, if the applicant chooses to receive upfront lump sum amount V from the reverse mortgage, the present value of the time-sharing contract is
PV(X-yr rent & maintenance)=PV(1-yr rent & maintenance)·{1+[1−1/(1+12r)^{X-1}]/(12r)}

Hence, in this case, the applicant can afford to sign the contract for this time-sharing arrangement, if
V>PV(X-yr rent & maintenance)

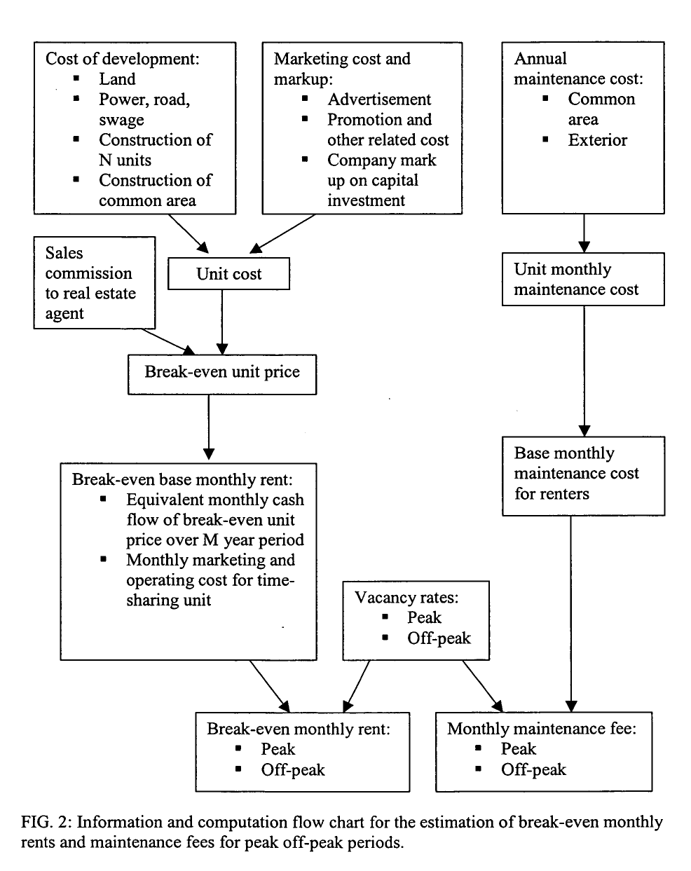

In FIG. 2, the break-even unit price P is sum of the unit cost and sales commission to real estate agents. Conversion of the break-even unit price to equivalent monthly cash flows (EQCF) over the specified period M year is as follows.
EQCF=r·P/[1−1/(1+r)^{12M}]

Break-even base monthly rent (Base_rent) is sum of EQCF and the unit monthly marketing cost for time-sharing operation.

Let
vac_peak: vacancy rate for peak period
vac_off-peak: vacancy rate for off-peak period
Rent_peak: break-even rent for peak period
Rent_off-peak: break-even rent for off-peak period
Main_peak: maintenance fee for peak period
Main_off-peak: maintenance fee for off-peak period

Then,

Rent_peak=Base_rent/(1-vac_peak)

Rent_off-peak=Base_rent/(1-vac_off-peak)

Main_peak=Base_Main/(1-vac_peak)

Main_off-peak=Base_Main/(1-vac_off-peak)

The above-described arrangement is merely illustrative of the principles of the present invention. Numerous modifications and adaptations thereof will be readily apparent to those skilled in the art without departing from the spirit and scope of the present invention.

What is claimed is:

1. A computer-implemented method used in determining the affordability of retirement community living on time-sharing basis for a retired homeowner who would finance this arrangement primarily by reverse mortgages.

2. The method of claim 1, wherein determining monthly cash flows from reverse mortgages includes: inputting the appropriate information on the applicant; inputting the applicant's age, the location of the applicant's house, the assessed house value, values of other assets, etc., given the current mortgage rate.

3. The method of claim 1, wherein determining whether an applicant can afford to stay in the retirement community includes: monthly rents and maintenance fees for peak and off-peak periods.

4. The method assesses the feasibility of developing retirement communities for developers.

5. The method of claim 4, wherein comparing the break-even monthly rents plus maintenance fees per unit of a retirement community for peak and off-peak periods and the estimated monthly cash flows of reverse mortgage for average retired homeowners. Unit means a living quarter assigned to a tenant or an owner. If the retirement community consists of condominiums within the compound, it is a condominium unit.

6. The method of claim 5, wherein determining break-even monthly rents per unit for peak and off-peak periods: inputting break-even base monthly rent per unit; inputting peak and off-peak period vacancy rates.

7. The method of claim 6, wherein determining break-even base monthly rent per unit: converting the break-even unit price to equivalent monthly cash flow over a specified period (e.g., fifteen years); inputting managing and advertising cost for time-sharing operation per unit.

8. The method of claim 7, wherein determining the break-even unit price: inputting the cost of development of the retirement community; marketing cost and company markup; sales commission to real estate agents.

9. The method of claim 5, wherein determining monthly maintenance fees per unit for peak and off-peak periods: inputting base monthly maintenance cost per unit; inputting vacancy rates for peak and off-peak periods for rental units.
